(19) United States
(12) Patent Application Publication
(10) Pub. No.: US 2013/0319176 A1
(43) Pub. Date: Dec. 5, 2013

(54) MIXING AND KNEADING MACHINE FOR CONTINUOUS CONDITIONING PROCESS & METHOD FOR CONDITIONING METALS

(71) Applicants: Rico Trachsel, Eimeldingen (DE); Martin Werner Trost, Bad Sackingen (DE); Martin Schotzau, Augst (CH)

(72) Inventors: Rico Trachsel, Eimeldingen (DE); Martin Werner Trost, Bad Sackingen (DE); Martin Schotzau, Augst (CH)

(73) Assignee: Buss AG, Pratteln (CH)

(21) Appl. No.: 14/000,037

(22) PCT Filed: Feb. 9, 2012
(86) PCT No.: PCT/CH12/00035

§ 371 Date: Aug. 16, 2013

(30) Foreign Application Priority Data
Feb. 21, 2011 (CH) 302/11

(51) Int. Cl. B01F 15/06; B01F 7/08

(52) U.S. Cl. CPC B01F 15/063; B01F 7/08
USPC 75/594; 266/215; 266/99; 75/585; 75/671

(57) ABSTRACT

What is proposed is a mixing and kneading machine (1) which is suitable, in particular, for continuously conditioning metals such as aluminium or magnesium for a subsequent die-casting operation. To this end, the mixing and kneading machine (1) has a worm shaft (3) which rotates and at the same time moves in translation in the axial direction in a housing (2). The temperature of both the housing (2) and the worm shaft (3) is controlled by means of a flowing gas in such a manner that the conditioned metal assumes a thixotropic state when it leaves the mixing and kneading machine (1).

The invention pertains to a mixing and kneading machine for continuous conditioning processes according to Claims 1 to 17. The invention furthermore pertains to a method for conditioning metals by means of a mixing and kneading machine in accordance with Claims 18 to 22. The invention ultimately also pertains to the utilization of a mixing and kneading machine in accordance with Claim 23.

Until now, mixing and kneading machines of the pertinent type were predominantly used for conditioning free-flowing (powders, granulates, flakes, etc.), plastic and/or pasty masses and materials.

In conventional mixing and kneading machines, the housing is usually tempered by means of a liquid medium. Water is preferably used at temperatures below approximately 150° C. while oils are normally used at higher temperatures. However, oils are also not suitable for use at temperatures above 400° C. Depending on the design and the utilization of the mixing and kneading machine, the aforementioned mediums are used for cooling and/or heating the housing. The tempering of the housing naturally also makes it possible to directly influence the temperature of the work chamber and therefore the temperature of the materials accommodated in the work chamber.

DE 40 14 408 C1 discloses a device for heating materials while they are processed in mixing and kneading machines of the initially cited type. This device comprises a rigid and immovable conduit that extends into a blind bore of the working means. The conduit is provided with an open end. An annular gap is formed between the aforementioned conduit and the blind bore in the working means. A gaseous medium, preferably air or an inert gas, can be introduced into the interior of the working means through this rigid conduit, wherein said gaseous medium can subsequently flow back into a collection housing through the annular gap in order to be discharged into the atmosphere.

Although such a device is suitable for heating the working means, it is only able to introduce comparatively small amounts of energy into the work chamber.

The invention is based on the objective of enhancing a mixing and kneading machine realized in accordance with the preamble of Claim 1 in such a way that it can be operated with high temperatures and is particularly suitable for conditioning metals, e.g. aluminium or magnesium, such that they have a particularly advantageous temperature and structure for a subsequent die casting operation.

This objective is attained with a mixing and kneading machine, which shows the characteristics disclosed in characterizing portion of claim 1.

The basic objectives of being able to operate the mixing and kneading machine with high to very high temperatures and of the material being conditioned, particularly aluminium or magnesium, having a predetermined temperature and a homogenous structure at the outlet of the machine are attained in that the housing and the working means of the mixing and kneading machine are respectively provided with at least one channel for the forced flow-through of gaseous mediums in order to temper the process chamber, and in that the mixing and kneading machine features a heatable feed hopper and/or a heatable outlet nozzle.

Preferred enhancements of the mixing and kneading machine are disclosed in dependent Claims 2 to 17.

In a particularly preferred enhancement of the mixing and kneading machine, the tempering channels are formed by grooves that are recessed into the housing, wherein said grooves are closed by means of cover plates and the cover plates are fixed by means of spring elements. Such a design on the one hand makes it possible to provide tempering channels with a large cross section such that large amounts of energy—heat—can be supplied and removed by means of the tempering channels. On the other hand, the tempering channels can be produced in a relatively simple fashion because they do not have to be machined into the housing in a subsequent processing step such as, for example, a drilling operation. It is furthermore possible to realize practically arbitrary cross-sectional geometries. Tempering channels of this type are also insensitive to significant temperature differences because the cover plates are fixed by means of spring elements and thermally related distortions and expansions can, in contrast to welded joints or mechanical connections such as screw joints or the like, be compensated by the spring elements.

In another particularly preferred enhancement of the mixing and kneading machine, the working means not only rotates, but also carries out a translatory motion, i.e., it carries out a reciprocating motion—oscillates—in the axial direction. Particularly homogenous mixing of the material to be processed, as well as a particularly homogenous temperature distribution of said material, can be achieved with a thusly designed mixing and kneading machine.

Another objective of the invention can be seen in proposing a method for conditioning metals by means of a mixing and kneading machine realized in accordance with Claims 1 to 17, wherein said method makes it possible to condition metals, e.g. aluminium or magnesium, in such a way that they have a particularly advantageous temperature and structure for a subsequent die casting operation at the outlet of the machine.

This objective is attained with the characteristics disclosed in the characterizing portion of Claim 18, according to which the housing, as well as the working means, is tempered by means of a flowing gas in such a way that the metal being conditioned in the process chamber assumes a thixotropic state when it exits the mixing and kneading machine. In the thixotropic state, the particularly preferred metals such as aluminium or magnesium have a particularly advantageous temperature and structure for a subsequent die casting operation because the viscosity of the material is lowered under the influence of shearing forces in the thixotropic state. In this so-called semi-solid state, the metal can be very precisely pressed into moulds with low pressures. Since the other advantages of die-casting metals such as aluminium or magnesium in the thixotropic state are sufficiently known, they do not have to be discussed in greater detail at this point. Preferred enhancements of the method are defined in Claims 19-22.

The utilization of a mixing and kneading machine realized in accordance with one of Claims 1 to 17 is ultimately claimed in Claim 23. This claim specifically claims the utilization of a mixing and kneading machine for conditioning metals such as aluminium or magnesium, in which the respective metal is conditioned in the mixing and kneading machine in such a way that it is in a thixotropic state and has an optimized temperature and structure for a subsequent die casting operation when it exits the machine.

A preferred exemplary embodiment of the invention is described in greater detail below with reference to the drawings. In these drawings:

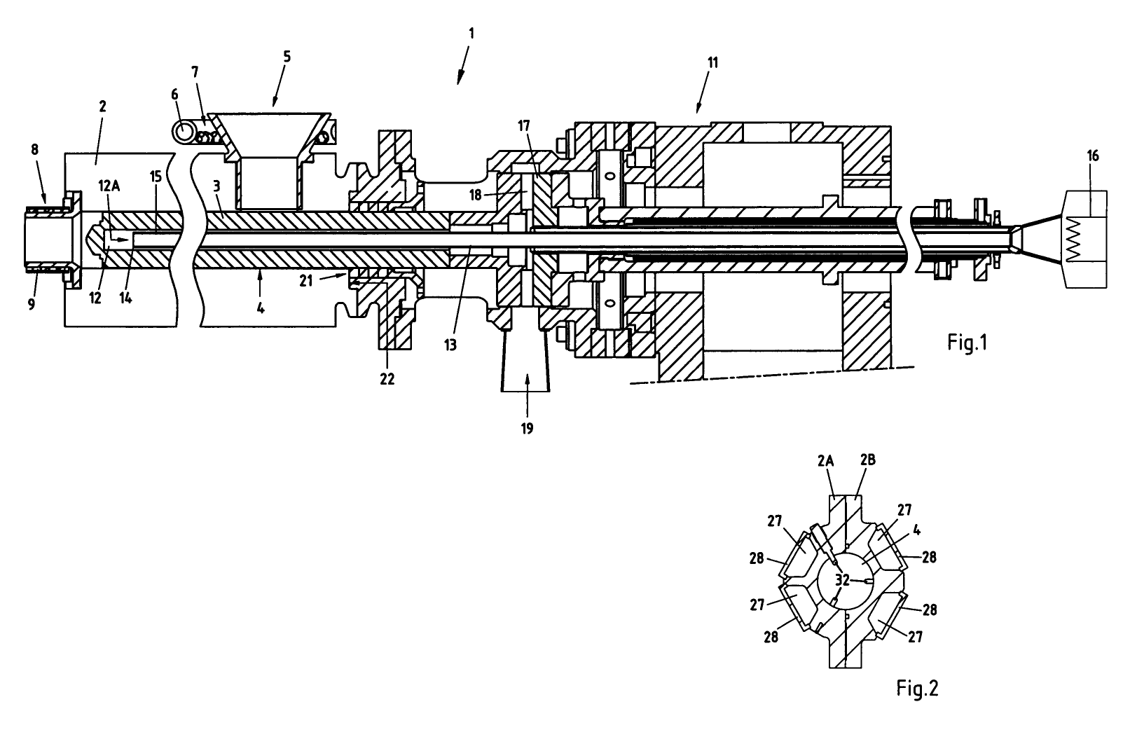

FIG. 1 shows a longitudinal section through a schematically illustrated mixing and kneading machine;

FIG. 2 shows a cross section through the housing of the schematically illustrated mixing and kneading machine;

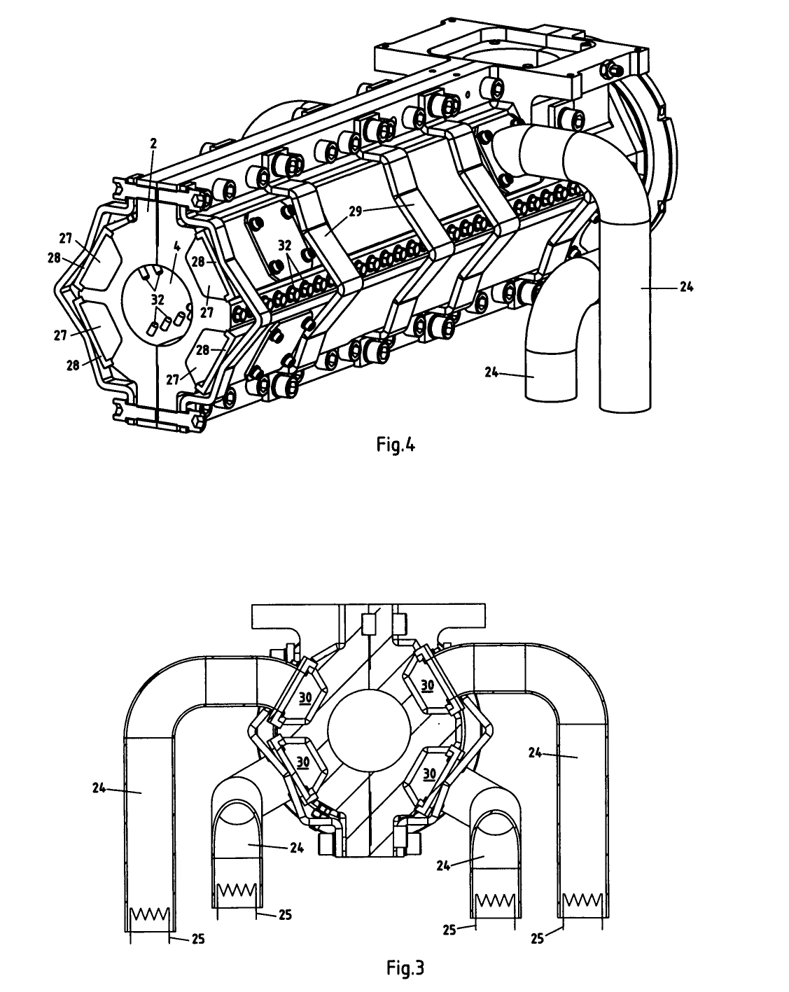

FIG. 3 shows a cross section through the housing of the mixing and kneading machine, as well as parts on its periphery;

FIG. 4 shows the mixing and kneading machine in the form of a perspective side view;

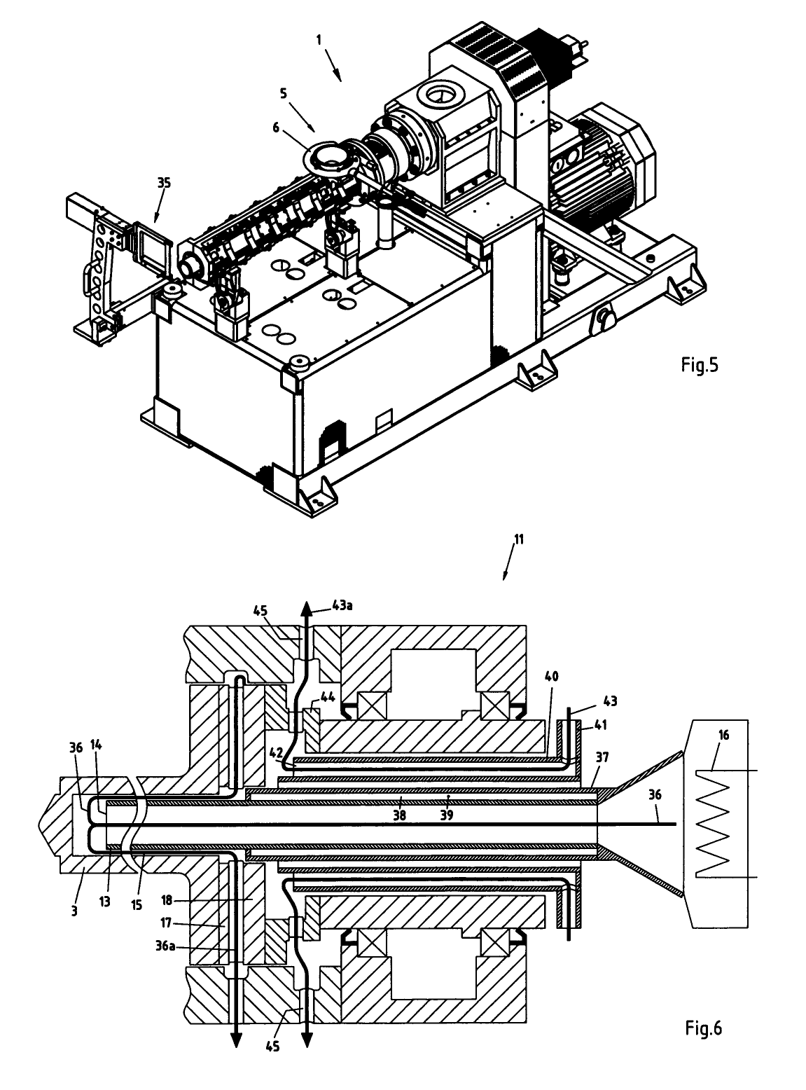

FIG. 5 shows the mixing and kneading machine in the form of a perspective overall view, and

FIG. 6 shows a longitudinal section through the gear mechanism and parts of the working means.

FIG. 1 shows a longitudinal section through a schematically illustrated mixing and kneading machine 1 that is suitable, in particular, for continuously conditioning light metals such as aluminium or magnesium for a subsequent die casting operation. Any reference to aluminium or magnesium in the following description should not be interpreted as a reference to pure aluminium or magnesium only, but also implies, in particular, their alloys.

The mixing and kneading machine 1 features a working means in the form of a worm shaft 3 that is enclosed by a housing 2 and provided with a plurality of spirally extending worm blades. The not-shown worm blades of the worm shaft 3 are interrupted in the circumferential direction in order to create axial through-openings for kneading bolts or kneading teeth arranged on the housing 2 as described in greater detail further below. In addition to the actual rotation, the worm shaft 3 also carries out an axial motion, i.e., a translatory motion. The worm shaft 3 preferably carries out one or two reciprocating motions per revolution. The actual process chamber 4 is formed between the inner wall of the housing 2 and the worm shaft 3.

In the present example, the mixing and kneading machine is designed for a maximum operating temperature of 750° C., wherein the rotational speed of the worm shaft lies between approximately 10 and 500 l/min and the ratio P1/Da of the process chamber length P1 to the outside diameter of the worm shaft Da lies between 7 and 15.

A feed hopper 5 is arranged on the intake side in order to feed the materials to be processed to the mixing and kneading machine 1 while an outlet nozzle 8, through which the conditioned material can exit the machine, is provided on the outlet side. In the present context, the term feed hopper is used for any type of inlet opening, feed opening, etc., and not only refers to a funnel-shaped inlet. The feed hopper 5 is provided with a heater 6 that comprises an annular element provided with a plurality of gas nozzles 7. The feed hopper 5 is largely insulated relative to the housing 2 because it only contacts the housing 2 with comparatively small surfaces. It is preferred to use a heater 6 that can be operated with fossil fuels because these heaters make it possible to supply large amounts of energy. In the present example, the heater 6 is realized in the form of a gas burner such that high heating capacities and high temperatures can be achieved. If so required, it would naturally also be possible to provide a different type of heater such as, for example, an electric resistance or induction heater. The outlet nozzle 8, in contrast, is preferably provided with an electric heating element 9.

A gear mechanism 11 is arranged upstream of the housing referred to the axial direction and causes the rotational motion, as well as the reciprocating motion, of the—working means—worm shaft 3. The gear mechanism 11 is coupled to the worm shaft 3 by means of a fan wheel 17. The worm shaft 3 is provided with a channel in the form of an axial bore 12 that does not extend completely through the worm shaft 3, but is rather realized in the form of a blind bore that ends before it reaches the distal end of the worm shaft 3. In addition, the gear mechanism 11 and the fan wheel 17 are also provided with an axial bore such that a continuous channel 12A is formed, by means of which the worm shaft 3 can be tempered. A central pipe 13 is arranged within the aforementioned channel 12A. This pipe 13 is arranged stationarily, i.e., in a non-rotating fashion, and ends a short distance before the end of the blind bore 12. The aforementioned pipe 13 is supported in the channel 12A by means of not-shown bearings.

An annular gap 15 remains between the outer side of the pipe 13 and the wall of the channel 12A and proximally leads into the fan wheel 17. The pipe 13 serves for supplying a gaseous medium. In more specific terms, hot air is supplied by means of a heater fan 16 arranged on the intake end of the pipe 13, wherein this hot air is discharged on the pipe end 14 and flows back to the fan wheel 17 through the annular gap 15. The fan wheel 17 rotates together with the worm shaft 3 and is provided with fan blades 18. These fan blades 18 cause a suction effect in the annular gap 15 such that the flow-through of the hot air is promoted and this hot air is forcibly discharged outward. The discharged hot air is fed to an exhaust air pipe 19, from where it is routed into a (not-shown) collection container. The air conduction through the annular gap 15 makes it possible to influence the temperature of the worm shaft 3 and therefore naturally also the temperature of the material accommodated in the process chamber 4. The fan wheel 7 is made of a ceramic material and simultaneously serves as an insulator by thermally insulating the gear mechanism 11 relative to the worm shaft 3.

If so required, the fan wheel 17 may be realized in the form of a two-part fan wheel that features a hot gas section and a cold gas section. As mentioned above, the hot gas section serves for discharging the hot gases outward from the annular gap 15. The cold gas section is described in greater detail below with reference to FIG. 6. Such a fan wheel may be constructed like an exhaust gas turbocharger, wherein the hot gas section corresponds to the exhaust gas side and the cold gas section corresponds to the fresh air side. However, the fan wheel 17 is not driven by the exhaust gas flow, but rather mechanically coupled to the working means 3.

At least one additional (not-shown) pipe is preferably arranged coaxial to the segment of the pipe 13 that extends through the gear mechanism 11, wherein this additional pipe serves as a thermal insulator due to the fact that a static air cushion is formed between the gear mechanism 11 and the stationary pipe 13. A cooling effect may be alternatively or additionally realized by means of a flowing cooling gas that is either routed through the aforementioned additional pipe or, if necessary, another coaxial pipe. A preferred embodiment is also described in greater detail below with reference to FIG. 6.

In order to seal the process chamber 4 on the intake side, packings 21 are supported on the worm shaft 3 in a floating fashion and tensioned against the face 22 of the housing 2 in the axial direction. The entire process chamber 4 is realized and sealed in such a way that liquid aluminium or magnesium can be processed therein. It goes without saying that all components that are subjected to high thermal stresses are made of heat-resistant materials and/or provided with heat-resistant layers. In addition, components that come in contact with the material to be processed—liquid aluminium or magnesium—are made of materials and/or provided with layers that neither chemically nor physically react with aluminium and/or magnesium. The components subjected to high thermal stresses are preferably made of heat-resistant steel while the housing is preferably armour-plated by means of welding on the side that forms the process chamber. Other highly stressed elements may also be coated, for example, with a permanent refractory dressing.

The worm shaft 3 preferably has a modular design and is realized in the form of a so-called insert shaft, in which individual worm segments can be attached onto a splined shaft. In this way, the shaft can be modularly configured and the separate modules can be individually adapted to the desired or required specifications. At least one of the modules preferably causes a high shearing effect such that the solid components being formed, namely crystallizing tendrides, are disaggregated and the conditioned mass therefore is as fine-grained and homogenous as possible.

FIG. 2 shows a schematic cross section through the housing 2 of the mixing and kneading machine 1 that consists of two halves 2A, 2B. The housing 2 preferably consists of temperature-resistant steel or steel alloy. In this illustration, four grooves 27 are recessed into the housing 2, wherein said grooves extend axially along the housing 2 and are closed by means of cover plates 28 in order to form tempering channels. The two housing halves 2A, 2B are preferably manufactured of a massive steel block by means of a machining operation such as milling, drilling or the like. The grooves 27 are also simultaneously produced during the manufacture of the respective housing half 2A, 2B. If so required, the housing 2 could also be manufactured by means of casting, wherein the grooves 27 are preferably produced directly during the casting operation. The cover plates 28 are fixed by means of spring elements as described in greater detail below with reference to FIG. 3. This illustration also shows kneading bolts 32 that protrude into the process chamber 4. Several kneading bolts 32 arranged axially along the process chamber 4 are preferably provided with temperature sensors such that the temperature of the material situated in the process chamber can be measured during the conditioning/processing along the process chamber 4. If so required, a few temperature sensors may also be radially offset. In the present example, it is particularly important that the material has a predetermined temperature at the outlet of the mixing and kneading machine 1.

FIG. 3 shows a cross section through the housing of the mixing and kneading machine, as well as parts on its periphery. This illustration shows, in particular, four hot gas supply conduits 24 that are respectively connected to one of the tempering channels 30. An electric heating element 25 is arranged upstream of each of the for hot gas supply conduits 24 in order to heat the gas to be supplied—air—to the desired temperature. The heating elements 25 are designed in such a way that the air flowing through can be heated to approximately 750° C. Each housing half can be tempered separately as shown. The housing halves are preferably also divided into several tempering zones in the axial direction as described in greater detail below.

On the outlet side, the tempering channels 30 are provided with (not-shown) hot gas discharge conduits. These hot gas discharge conduits preferably also lead into the aforementioned collection container such that the hot gases discharged from the worm shaft are combined with the hot gases discharged from the housing. The enthalpy of the discharged gases is preferably utilized for heating the hot mediums to be supplied to the tempering channels 30. This utilization can be realized directly by circulating the hot gases in a circuit. Alternatively, the utilization could be realized, for example, by means of a heat exchanger.

FIG. 4 shows the housing of the mixing and kneading machine 1 in the form of a perspective exterior view. This illustration shows, in particular, the grooves 27 that are axially recessed into the housing 2, the cover plates 28, the spring elements 29 that serve for fixing the cover plates 28, as well as a plurality of kneading bolts 32. The spring elements 29 press against the respective cover plate 28 with their inwardly curved centre section such that the cover plate tightly adjoins a plane surface above the respective groove 27. Such a design has the advantage that tempering channels with large cross sections can be easily realized. Since the cover plates 28 are fixed by means of spring elements 29, they are able to withstand very high temperature differences up to several hundred degrees and to compensate the different temperature-related expansions resulting thereof, wherein this would be very difficult if the cover plates 28 are mechanically mounted by means of screw joints, welding or the like because the large-mass housing 2 does not heat up and cool down with the same speed as the cover plates 28. The spring elements 29 are fixed on the housing by means of a screw joint, namely by means of recessed tensioning rather than on-block tensioning. If the spring elements are fixed in this way, it is possible to compensate manufacturing tolerances when the spring elements 29 are bent during the installation such that all spring elements 29 press against the cover plates 28 with the same spring force.

This illustration furthermore shows two hot gas supply conduits 24, by means of which the hot gas can be supplied to the tempering channels. It goes without saying that each of the tempering channels formed by a groove 27 is respectively provided with a hot gas supply conduit 24, as well as a hot gas discharge conduit. A heating element for heating a gaseous medium, preferably air, is arranged upstream of each hot gas supply conduit. In the present example, the heating elements are designed for heating the air flowing through to temperatures in excess of 500° C. In order to compensate the pressure loss or the pressure difference in hot gas supply conduits 24 with different lengths, the shorter hot gas supply conduits may, if so required, be provided with throttles. It is preferred to provide several tempering zones along the housing 2 by dividing the tempering channels in the axial direction such that separate regions of the housing 2 can be individually tempered. Each of these tempering zones is provided with a hot gas supply conduit, as well as a hot gas discharge conduit, but the individual conduits are not illustrated in order to provide a better overview. The housing 2 is preferably divided into two to four different tempering zones in the axial direction, wherein each tempering zone is preferably provided with at least one temperature sensor.

The grooves 27 make it possible to realize tempering channels 30 with large cross sections such that the flowing gas is respectively able to transfer large amounts of energy to the housing or to absorb large amounts of energy in order to ultimately temper of the process chamber and therefore the material to be processed in the desired fashion.

The outer side of the housing is preferably provided with a thermal insulation that is also not illustrated in order to provide a better overview. The insulation may be divided into segments, wherein this is particularly advantageous if the housing 2 is divided into several different tempering zones in the axial direction. In this case, a separate insulation is preferably assigned to each individual tempering zone.

FIG. 5 shows the mixing and kneading machine in the form of a perspective overall view. This illustration on the one hand shows the gas heater 6 that annularly extends around the feed hopper 5. It furthermore shows a cutting device 35, by means of which the material exiting the outlet nozzle can be severed, for example, in order to be fed to a casting machine in batches.

It is preferred to provide a heated mould that is realized, for example, in the form of a pipe half in order to catch the mass that exits the nozzle and is in a semi-solid state. The aforementioned mould is not illustrated in the figure. Said mould may be moved from the mixing and kneading machine to the casting machine, for example, by means of a robot.

The tempering of the working means 3, as well as the cooling of the gear mechanism 11, is described below with reference to FIG. 6 that shows a longitudinal section through schematically illustrated components of the mixing and kneading machine, namely the gear mechanism 11 and components of the working means 3. The air 36 heated by means of the heater fan 16 flows through the central pipe 13 in the direction of the working means 3. At the end 14, the heated air 36 is discharged from the pipe 13 and flows back to the fan wheel through the annular gap 15, wherein this backflow is promoted by the suction effect of the fan blades 18. The discharged hot air 36a is then discharged through a (not-shown) exhaust air conduit and, if so required, routed into a (not-shown) collection container.

In order to prevent the hot gas 36 supplied through the central pipe 13 from excessively heating the gear mechanism 11, the central pipe 13 is surrounded by an additional pipe 37 that is arranged coaxial to the central pipe 13 in the region of the gear mechanism 11. Due to this additional pipe 37, an annular gap 38 with a static air cushion 39 that acts as an insulator is formed on the outer side of the central pipe 13. If so required, the first coaxial pipe 37 may be enclosed by an additional coaxial pipe 40 that is provided an inlet 41 and an outlet 42 as illustrated in the figure. This additional coaxial pipe 40 serves for the flow-through of cold air. The outlet 42 of the additional coaxial pipe 40 is preferably connected to the cold gas side 44 of the fan wheel 17. Cold air 43 is supplied through the inlet 41 of the additional (outer) coaxial pipe 40. This cold air 43 flows past the outer side of the inner coaxial pipe 37 and thusly cools this pipe. The cold air 43a is discharged through the outlet 42 of the additional coaxial pipe 40 and then flows outward through radial channels 45, wherein this outflow is promoted by the suction effect of the fan blades 43. If so required, it is possible to dispense with the assisting suction effect of the fan wheel 17 by merely moving the cold air 43 through the additional coaxial pipe 40 with the aid of a (not-shown) fan. In addition to cooling the gear mechanism 11, the cold air also cools the fan wheel 17. If so required, the exiting cool air can furthermore be used for cooling other components, connecting parts, housing parts, etc., by routing the cool air past the elements to be cooled. This can be achieved with a corresponding air conduction.

The function of the mixing and kneading machine is described in greater detail below with reference to conditioning aluminium for a subsequent die casting operation, wherein it is assumed, for example, that aluminium with a melting temperature on the order of approximately 650° C. is conditioned.

Before the material to be conditioned—aluminium—is supplied to the mixing and kneading machine 1, the machine is heated to such a degree that the temperature of the housing 2, as well as of the working means 3—worm shaft—and the process chamber 4, lies around the melting point of aluminium. This heating process is realized by supplying hot gas with a corresponding temperature through the tempering channels 30 of the housing 2 and the worm shaft 3.

Liquid aluminium, i.e. molten aluminium, is then supplied to the mixing and kneading machine 1 through the feed hopper 5. The feed hopper 5 is heated above the melting point of aluminium by means of the hot gas heater 6 such that portions of the aluminium that come in contact with the feed hopper 5 are prevented from solidifying and residues are prevented from adhering to the feed hopper 5. In any case, the feed hopper 5 is respectively heated to at least approximately 650° C. or above the melting point of the light metal to be processed, wherein this temperature can vary in dependence on the alloy of the material to be processed and the associated melting point and therefore should be interpreted as an order of magnitude only.

Alternatively, the material to be conditioned may naturally also be supplied in solid form such as, for example, in the form of granulate, pellets (globules, spherules), flakes, chips, powder or the like. However, the solid material is preferably heated prior to the metered addition, particularly to a temperature near the melting point, such that only comparatively little heat—energy—needs to be supplied into the mixing and kneading machine 1 until the ideal semi-solid state is reached.

The aluminium is transported forward on the one hand and homogenously mixed on the other hand by means of the worm shaft 3 that rotates and oscillates in the axial direction. The work chamber of the mixing and kneading machine is tempered in such a way that the aluminium is cooled to a temperature below the actual melting point when it reaches the outlet. The aluminium is specifically cooled to such a degree that it is in a thixotropic state at the outlet of the mixing and kneading machine 1. The term thixotropic state refers to a partially solidified state, in which the aforementioned material—aluminium—contains liquid fractions, as well as solid fractions. In the present example, a temperature between approximately 570° C. and 620° C. should be reached because the aluminium or aluminium alloy is in a thixotropic state at this temperature. As already mentioned above, aluminium has a particularly advantageous temperature and structure for a subsequent die casting operation in the thixotropic state. It goes without saying that the cited temperature range between 570° C. and 620° C. is merely an example and can vary in dependence on the required casting properties, as well as the respective alloy.

The temperature of the aluminium can be monitored and controlled by means of the temperature sensors arranged along the process chamber 4. For this purpose, the mixing and kneading machine is provided with a (not-shown) control unit, by means of which the parameters that are decisive for the temperature of the aluminium, particularly the temperature of the supplied hot gases, can be influenced. This is realized by activating the individual heating elements 16, 25 arranged upstream of the hot gas conduits. The temperature of the aluminium at the outlet naturally can also be influenced with the temperature of the feed hopper 5 and, in particular, with the temperature of the outlet nozzle 8.

It goes without saying that the cited temperatures can vary depending on whether pure aluminium or an aluminium alloy should be conditioned, wherein considerable differences with respect to the temperature may be required, in particular, for different aluminium alloys. This naturally also applies to magnesium and magnesium alloys.

The advantage of conditioning aluminium or magnesium by means of an inventive mixing and kneading machine can be seen in that the temperature in the process chamber and the temperature of the light metal to be processed can on the one hand be very precisely adjusted. On the other hand, it can be ensured that the material to be processed is homogenously mixed and has a homogenous structure, as well as a continuously uniform temperature referred to its cross section, wherein these aspects are very important because the temperature window, within which aluminium or magnesium is in the thixotropic state, is relatively narrow and lies on the order of ±5° C.

### LIST OF REFERENCE SYMBOLS

1. Mixing and kneading machine

2. Housing

3. Working means

4. Process chamber

5. Feed hopper

6. Heater

7. Gas nozzles

8. Outlet nozzle

9. Electric heating element

10.

11. Gear mechanism

12. Central bore

13. Central pipe

14. Pipe end

15. Annular gap

16. Heater fan

17. Fan wheel

18. Fan blades

19. Exhaust air pipe

20.

21. Packings

22. Face of housing

23.

24. Hot gas supply conduit

25. Heater

26.

27. Grooves

28. Cover plates

29. Spring elements

30. Tempering channel

31.

32. Kneading bolt

33. Temperature sensor

34.

35. Cutting device

36. Hot gas (air)

37. Additional coaxial pipe

38. Annular gap

39. Static air cushion

40. Additional coaxial pipe

41. Air inlet

42. Air outlet

43. Cold gas

44. Fan blades (cold gas side)

45. Radial channels

1. A mixing and kneading machine for continuous conditioning processes with a housing that encloses a process chamber and a working means that rotates in the housing, with a feed hopper for filling material to be conditioned into the process chamber and an outlet nozzle for the conditioned material, characterized in that the housing and the working means are respectively provided with at least one channel for the forced flow-through of gaseous mediums in order to temper the process chamber, and in that the mixing and kneading machine features a heatable feed hopper and/or a heatable outlet nozzle.

2. The mixing and kneading machine according to claim 1, characterized in that heating elements for heating a gaseous medium to temperatures in excess of 500° C. are arranged upstream of the aforementioned channels.

3. The mixing and kneading machine according to claim 1, characterized in that the working means is realized in the form of a worm shaft, wherein the worm shaft is provided with a central bore, through which a gaseous medium for tempering the worm shaft can be supplied.

4. The mixing and kneading machine according to claim 1, characterized in that the housing is provided with axially extending tempering channels, through which a gaseous medium for tempering the housing can be supplied.

5. The mixing and kneading machine according to claim 4, characterized in that the tempering channels are formed by grooves that are recessed into the housing and closed by means of cover plates, wherein the cover plates are fixed by means of spring elements.

6. The mixing and kneading machine according to claim 3, characterized in that the outlet of the bore recessed into the worm shaft is connected to a fan wheel that is coupled to the worm shaft and causes a suction effect in the aforementioned bore.

7. The mixing and kneading machine according to claim 6, characterized in that the fan wheel is made of ceramic material.

8. The mixing and kneading machine according to claim 3, characterized in that a stationary pipe is arranged in the aforementioned bore of the worm shaft, wherein an annular gap, through which the gaseous medium can flow back after being discharged from the pipe, is formed between the pipe and the central bore of the worm shaft.

9. The mixing and kneading machine according to claim 8, characterized in that the worm shaft is axially coupled to a gear mechanism and the aforementioned pipe extends outward through the gear mechanism in such a way that the gaseous medium can be routed to the worm shaft through the pipe.

10. The mixing and kneading machine according to claim 9, characterized in that at least one additional pipe is arranged coaxial to the segment of the central pipe that extends through the gear mechanism and defines an annular gap between itself and the central pipe, wherein the annular gap acts as a thermal insulator due to the fact that a static air cushion is formed therein.

11. The mixing and kneading machine according to claim 9, characterized in that another additional pipe is arranged coaxial to the segment of the central pipe that extends through the gear mechanism and provided with an inlet and an outlet, and in that means for the forced flow-through of a cold gas, particularly air, through the additional pipe are provided.

12. The mixing and kneading machine according to claim 11, characterized in that the aforementioned means comprise a fan and/or a fan wheel that is coupled to the working means, wherein the latter is provided with fan blades in order to generate a suction effect in the additional pipe.

13. The mixing and kneading machine according to one of the preceding claims, characterized in that several temperature sensors are arranged along the process chamber.

14. The mixing and kneading machine according to claim 1, one of the preceding claims, characterized in that the worm shaft carries out a reciprocating motion in addition to its rotation by oscillating in the axial direction, and in that a plurality of kneading bolts are arranged on the housing and protrude into the process chamber.

15. The mixing and kneading machine according to claim 13, characterized in that at least individual kneading bolts are provided with a temperature sensor for measuring the predominant temperature in the process chamber.

16. The mixing and kneading machine according to claim 1, characterized in that the housing features several tempering zones that can be individually tempered.

17. The mixing and kneading machine according to claim 16, characterized in that the tempering zones are arranged along the process chamber in the axial and/or radial direction.

18. A method for conditioning metals, particularly light metals and their alloys, by means of a continuously operating mixing and kneading machine provided with a housing that encloses a process chamber, a working means that rotates in the housing, as well as an outlet nozzle, characterized in that the process chamber is tempered by means of a gaseous medium in such a way that the metal being conditioned in the process chamber assumes a thixotropic state when it exits the outlet nozzle.

19. The method according to claim 18 for conditioning metals by means of a mixing and kneading machine realized in accordance with one of claims 1 to 17, characterized in that the housing, as well as the working means, is tempered by means of a flowing gas in such a way that the metal being conditioned in the process chamber assumes a thixotropic state when it exits the outlet nozzle.

20. The method according to claim 19, characterized in that the feed hopper and/or the outlet nozzle is/are heated to a temperature above 500° C.

21. The method according to claim 18, characterized in that the metal is supplied to the mixing and kneading machine in the liquid state.

22. The method according to claim 18, characterized in that the temperature of the worm shaft and/or the temperature of housing of the mixing and kneading machine is/are maintained between 500° C. and 750° C., particularly between 550° C. and 650° C., by means of the gaseous medium.

23. The method according to claim 19, characterized in that the process chamber is cooled by means of air that is heated to above 400° C., particularly above 500° C.

24. The method according to claim 18, characterized in that the enthalpy of the gases discharged from the tempering channels is directly or indirectly utilized for heating the gases to be supplied to the tempering channels.

25. The utilization of a mixing and kneading machine realized in accordance with claim 1, characterized in that the mixing and kneading machine is used for conditioning light metals or their alloys, particularly aluminium, magnesium or their alloys, wherein the respective material is conditioned in the mixing and kneading machine in such a way that it is in a thixotropic state and has an optimized temperature and structure for a subsequent die casting operation at the outlet of the mixing and kneading machine.

26. A mixing and kneading machine for continuous conditioning processes with a housing that encloses a process chamber and a working shaft that rotates in the housing, with a feed hopper for filling material to be conditioned into the process chamber and an outlet nozzle for the conditioned material, comprising:
at least one channel defined in each of the housing and the working shaft for the forced flow-through of gaseous mediums in order to temper the process chamber, wherein the at least one channel defined in the housing includes a plurality of grooves recessed into the housing;
one or more components for heating the feed hopper and/or the outlet nozzle; and
a plurality of cover plates arranged to close the plurality of grooves recessed into the housing, the cover plates held to the housing by one or more spring elements.

27. A mixing and kneading machine for continuous conditioning processes with a housing that encloses a process chamber and a working shaft that rotates in the housing, with a feed hopper for filling material to be conditioned into the process chamber and an outlet nozzle for the conditioned material, comprising:
a channel defined in each of the housing and the working shaft for the forced flow-through of gaseous mediums in order to temper the process chamber;
one or more components for heating the feed hopper and/or the outlet nozzle; and
a fan wheel coupled to the working shaft adjacent and configured and arranged to generate a suction effect in the channel in the working shaft.

28. A mixing and kneading machine for continuous conditioning processes with a housing that encloses a process chamber and a working shaft that rotates in the housing and that is coupled at one end to a gear mechanism, with a feed hopper for filling material to be conditioned into the process chamber and an outlet nozzle for the conditioned material, comprising:
at least one channel defined in each of the housing and the working shaft for the forced flow-through of gaseous mediums in order to temper the process chamber, the channel in the working shaft including a portion extending through the gear mechanism coupled to the working shaft;
one or more components for heating the feed hopper and/or the outlet nozzle;
a pipe separate from and coaxial to the portion of the channel through the working shaft that extends through the gear mechanism, the pipe provided with an inlet and an outlet; and
means for the forced flow-through of a cold gas through the pipe.
